(19) United States
(12) Patent Application Publication
(10) Pub. No.: US 2010/0049579 A1
(43) Pub. Date: Feb. 25, 2010

(54) DATA PROCESSING APPARATUS, CONTROL METHOD THEREOF, MANAGEMENT SYSTEM, AND STORAGE MEDIUM

(75) Inventor: Katsunari Suzuki, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/543,962

(22) Filed: Aug. 19, 2009

(30) Foreign Application Priority Data
Aug. 21, 2008 (JP) 2008-212626

(51) Int. Cl. G06Q 10/00; G06F 12/14

(52) U.S. Cl. 705/9; 726/33

(57) ABSTRACT

A control method for controlling a data processing apparatus capable of communicating with a management apparatus that manages a starting date and time and an ending date and time of a conference to be held in a conference room and a presence/absence of a participant attending the conference in the conference room includes storing electronic data managed in association with the conference in a storage unit, and invalidating the electronic data stored in the storage unit based on the starting date and time of the conference and the presence/absence of the participant in the conference room or the ending date and time of the conference and a presence/absence of a person in the conference room, which are managed by the management apparatus.

### BACKGROUND OF THE INVENTION

1. Field of the Invention

The present invention relates to a data processing apparatus, a control method thereof, a management system, and a storage medium.

2. Description of the Related Art

Conventionally, there is a data processing apparatus, such as a multifunction peripheral (MFP), which can store conference materials as electronic data in a storage unit. The data processing apparatus prints the electronic data according to an instruction from a user.

By using such a data processing apparatus, members attending a conference can previously store the conference material in the storage unit of the data processing apparatus and print the stored conference material when the conference is held.

Further, if such a data processing apparatus is installed in a conference room, it becomes unnecessary for the members attending the conference to previously print the conference material before moving to the conference room. The members attending the conference can store the conference material in the data processing apparatus inside the conference room from a host computer outside the conference room via a network. The members attending the conference can thus print the conference material as necessary after entering the conference room. However, a conference room may be used by a large number of attending members, so that it is necessary to maintain the security of the conference material stored in the storage unit of the data processing apparatus.

For example, in a Secure Print system, the user can register a password for accessing data stored in the storage unit, and the data can be output by the user inputting the password. Printing of the data by a third person who does not know the password can thus be prevented.

Further, Japanese Patent Application Laid-Open No. 2004-266456 discusses deleting the data stored in the storage unit according to a storage life set to the storage unit. As a result, lowering of the security level due to unlimited storage of the data in the storage unit of the data processing apparatus can be prevented.

However, the above-described conventional techniques are not designed to invalidate the electronic data according to the starting and ending date and time of the conference and the presence of the members attending the conference inside the conference room.

### SUMMARY OF THE INVENTION

According to an aspect of the present invention, a data processing apparatus capable of communicating with a management apparatus that manages a starting date and time and an ending date and time of a conference to be held in a conference room and a presence/absence of a participant attending the conference in the conference room is provided. The data processing apparatus includes a storage unit configured to store electronic data managed in association with the conference, and a control unit configured to invalidate the electronic data stored in the storage unit based on the starting date and time of the conference and the presence/absence of the participant in the conference room or the ending date and time of the conference and a presence/absence of a person in the conference room, which are managed by the management apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a conference system according to an exemplary embodiment of the present invention.

FIG. 2 is a block diagram illustrating a hardware configuration of a client personal computer (PC), a conference room reservation server, and an entry/exit management server illustrated in FIG. 1.

FIG. 3 is a block diagram illustrating a hardware configuration of an image forming apparatus installed in the conference room illustrated in FIG. 1.

FIG. 4 is a flowchart illustrating an example of a data processing procedure in a server apparatus according to an exemplary embodiment of the present invention.

FIG. 5 is a flowchart illustrating an example of a data processing procedure in the server apparatus according to an exemplary embodiment of the present invention.

FIGS. 6A, 6B, 6C, and 6D illustrate examples of a user interface displayed on a display apparatus of the client PC illustrated in FIG. 1.

FIG. 7 is a flowchart illustrating an example of a data processing procedure in the server apparatus according to an exemplary embodiment of the present invention.

FIG. 8 illustrates an example of a process of deleting a conference material according to an exemplary embodiment of the present invention.

FIG. 9 illustrates an example of a process of deleting a conference material according to an exemplary embodiment of the present invention.

FIG. 10 illustrates an example of a process of deleting a conference material according to an exemplary embodiment of the present invention.

FIG. 11 illustrates an example of a process of deleting a conference material according to an exemplary embodiment of the present invention.

FIG. 12 illustrates a memory map of a storage medium that stores various data processing programs readable by the server apparatus according to an exemplary embodiment of the present invention.

### DETAILED DESCRIPTION OF THE EMBODIMENTS Various exemplary embodiments, features, and aspects of the invention will be described in detail below with reference to the drawings.

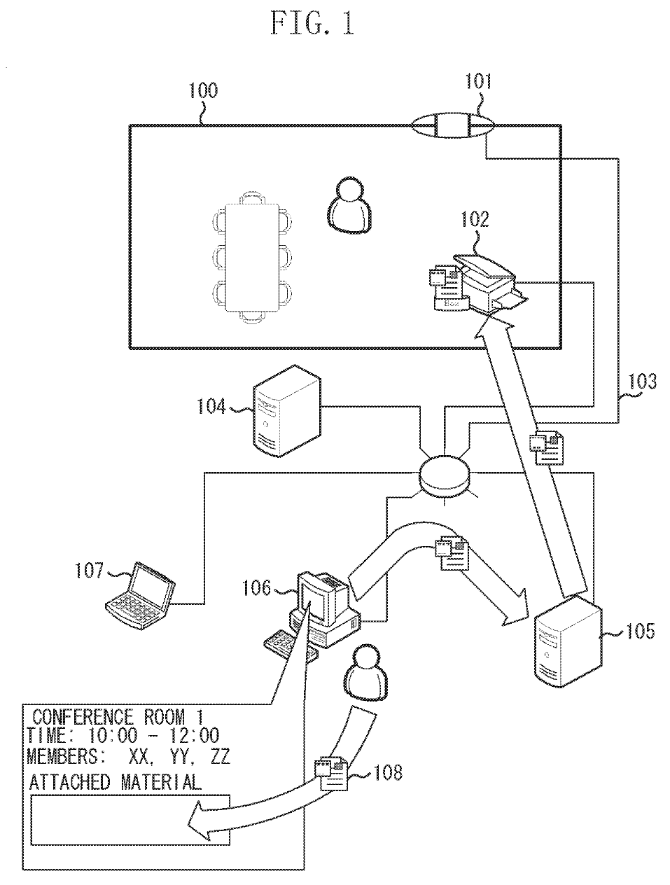

FIG. 1 illustrates an example of a configuration of a conference system according to an exemplary embodiment of the present invention. Referring to FIG. 1, an image forming apparatus 102, i.e., an example of a data processing apparatus, is installed in a conference room 100, in which a gate device 101 manages entry and exit of persons. Further, an entry/exit management server 104 for the conference room 100, a conference room reservation server 105, and client PCs 106 and 107 can communicate with each other.

For example, the image forming apparatus 102 illustrated in FIG. 1 is an MFP, including a scanner unit and a printer unit, which performs an image input/output process. Further, the image forming apparatus 102 includes an external storage device for storing data input from the scanner unit or an external host computer. The external storage device includes a non-volatile storage medium such as a hard disk (HD) and includes a plurality of BOX regions for storing the data. The present exemplary embodiment is described using the MFP including a plurality of functions as an example. However, the present exemplary embodiment can be applied to a printer apparatus that includes only a single function.

The gate device 101 is a doorway, through which members (i.e., users of the conference system, hereinafter also referred to as users) can enter and exit the conference room 100. The conference room 100 has at least one gate device 101 and is physically separated from the outside by walls. To simplify the description, the present exemplary describes an example in which the conference system includes one conference room 100. However, the conference system can include a plurality of conference rooms.

Further, the gate device 101 includes a reader/writer unit (not illustrated) that can read and write information stored in a user identification (ID) card which employs radio frequency identification (RFID). When the user places the user ID card near the reader/writer unit, the gate device 101 reads the user ID from the user ID card and transmits the user ID to the entry/exit management server 104. If entry permission is received from the entry/exit management server 104, a gate of the gate device 101 is unlocked. As described above, the user ID is read by the gate device 101 every time the user enters and exits the conference room 100. As a result, the conference room system can recognize whether a member carrying the user ID card employing the RFID enters or exits the conference room. A network 103 connects the gate device 101, the MFP 102, and various server apparatuses to be described below.

The entry/exit management server 104 manages whether an arbitrary person is inside the conference room 100 or has exited the conference room 100 based on information from the gate device 101. For example, when the entry/exit management server 104 receives the user ID from the gate device 101, the entry/exit management server 104 also receives information on whether the user has placed the user ID card near the reader/writer unit outside or inside the conference room. The entry/exit management server 104 then determines whether the user that corresponds to the received user ID is authorized to enter the conference room 100. If the entry/exit management server 104 determines that the user is authorized to enter the conference room 100, the entry/exit management server 104 notifies the gate device 101 of allowing the user to enter the conference room 100. In such a case, if the entry/exit management server 104 has received information indicating that the user ID card has been placed near the reader/writer unit outside the conference room 100, the entry/exit management server 104 stores information indicating that the user has entered the conference room 100 and is inside the conference room 100. Further, if the entry/exit management server 104 has received information indicating that the user ID card has been placed near the reader/writer unit inside the conference room 100, the entry/exit management server 104 stores information indicating that the user has exited the conference room 100 and is outside the conference room 100. As a result, the entry/exit management server 104 can manage whether the user is present in the conference room 100.

The conference room reservation server 105 manages the conference room 100 by registering information about conference starting/ending time and conference members using the conference room 100. The conference starting time and the conference ending time can be the date and time the conference starts and can be set in units of hours, minutes, or seconds.

By using the client PC 106 or 107, the user can input conference reservation information to the conference room reservation server 105 to reserve the conference room 100. Further, when the user uses the client PC 106 or 107 to reserve the conference room, the user can store a conference material 108 to be used in the conference in the BOX region of the image forming apparatus 102.

For example, the user can activate a conference room reservation application on the client PC 106 and designate the conference material 108. The user can thus store the document data in a hard disk drive (HDD) of the image forming apparatus 102 via the conference room reservation server 105. The user can then operate the image forming apparatus 102 inside the conference room 100 to print out the document data stored in the HDD. The functions of the conference room reservation server 105 and the entry/exit management server 104 can be performed by one server or separately by each server as described in the present exemplary embodiment.

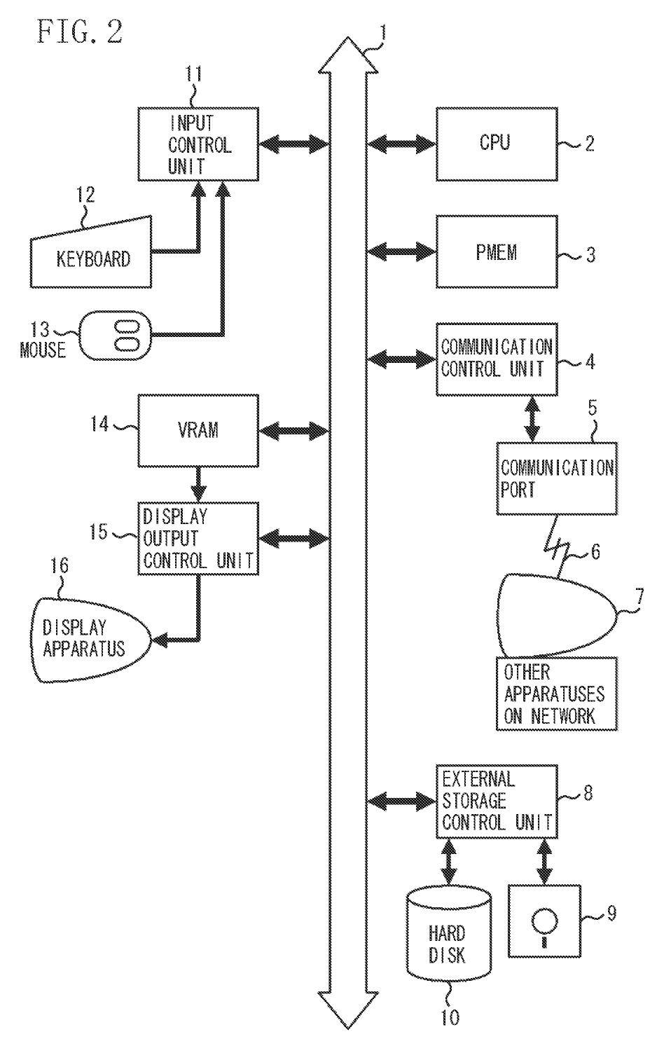

FIG. 2 is a block diagram illustrating the hardware configuration of the client PCs 106 and 107, the conference room reservation server 105, and the entry/exit management server 104.

Referring to FIG. 2, a system bus 1 connects to each of the blocks configuring the apparatus. A central processing unit (CPU) 2 reads out as appropriate a program for performing a process from a hard disk 10 to a program memory (PMEM) 3 and executes the program. Further, data input by a user from a keyboard 12 is stored as code information in the PMEM 3, which is also a text memory. A communication control unit 4 controls input and output of data in a communication port 5. A signal output from the communication port 5 is transmitted to a communication port of another apparatus 7 on the network via a communication line 6.

The present exemplary embodiment describes the network as a local area network (LAN). However, the present invention can be applied when the communication port and the communication line connected to the communication control unit 4 are a general public line.

An external storage control unit 8 controls read/write access to a floppy disk (FD) 9 and the HD 10, which store data files.

An input control unit 11 is connected to input devices such as the keyboard 12 and a pointing device 13. The user operates the keyboard 12 to instruct the system to operate.

Further, the pointing device 13 is used by the user to instruct editing of image information on the display apparatus 16. For example, the user freely moves the cursor on the display apparatus 16 using the pointing device 13, selects a command icon in a command menu, and instructs execution of a process. A display output control unit 15 displays on the display apparatus 16 the data stored in a video image memory (VRAM) 14 as bitmap data.

In the present exemplary embodiment, the programs are stored in the HD 10. However, the programs can also be stored in a storage medium such as the FD 9.

Further, the programs can be stored in other apparatuses connected to the network.

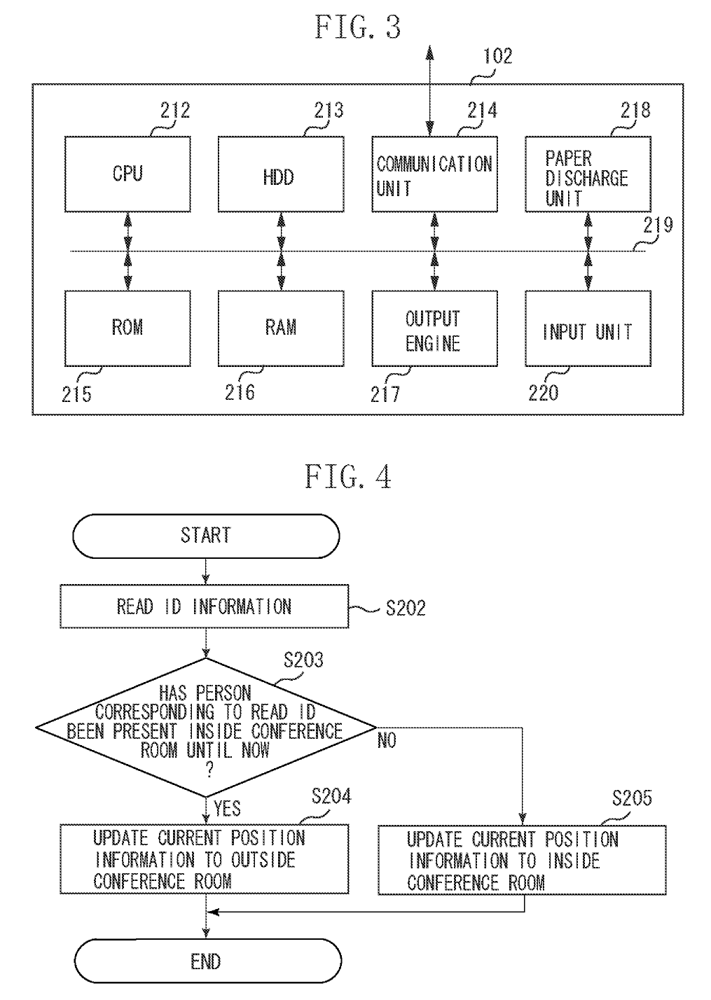

FIG. 3 is a block diagram illustrating the hardware configuration of the image forming apparatus 102 installed inside the conference room 100 illustrated in FIG. 1.

Referring to FIG. 3, the image forming apparatus 102 includes a CPU 212, which controls the entire apparatus, and an HDD 213, which is a mass storage device for storing a print job, which is composed of print data and print settings. The HDD 213 includes a plurality of BOX regions, and the BOX regions are managed as regions for temporarily storing conference materials. Each of the plurality of BOX regions can be used for each user or for each conference. Further, the image forming apparatus 102 can delete the conference material stored in the BOX region according to a conference material deletion instruction received from the conference reservation server 105.

Furthermore, the image forming apparatus 102 includes a communication unit (network interface ) 214 and a read-only memory (ROM) 215, which stores programs and font data for the image forming apparatus 102 to function as an MFP.

Moreover, the image forming apparatus 102 includes a random access memory (RAM) 216 used as a work area, a buffer memory, and for rasterizing a print image, an output engine 217, and a paper discharge unit 218. The image forming apparatus 102 also includes an input unit 220, which functions as an operation panel composed of a display unit and various input switches, and a bus 219, which connects the above-described components.

The communication unit 214 performs protocol conversion on data output from and input to the image forming apparatus 102. The communication unit 214 can thus perform data communication with the client PCs 106 and 107, the conference room reservation server 105, and the entry/exit management server 104 via the network according to a predetermined protocol.

The output engine 217 includes a printing unit that employs an inkjet method or a laser beam method, and performs printing under control of the CPU 212. However, the present invention is not limited by the printing methods. The paper discharge unit 218 discharges a printing sheet on which the output engine 217 has printed (i.e., a printout) to a discharge tray (not illustrated).

FIG. 4 is a flowchart illustrating a data processing procedure in the server apparatus according to the present exemplary embodiment. The present example describes a process performed by the entry/exit management server 104, which manages entry and exit of members to and from the conference room 100 based on the information acquired from the gate device 101. Each step in the flowchart is realized by the CPU 2 of the entry/exit management server 104 executing control programs stored in the HD 10 or the PMEM 3.

As described above, in the present system, the member entering or exiting the conference room 100 places the user ID card (hereinafter referred to as an IC card) near the reader/writer unit of the gate device 101. The gate device 101 that corresponds to the reader/writer unit to which the IC card is placed near transmits the user ID to the entry/exit management server 104.

In step S202, the CPU 2 of the entry/exit management server 104 reads the user ID transmitted from the gate device 101. The CPU 2 then determines whether the user corresponding to the user ID is authorized to enter the conference room 100 based on an entry authorization management table stored in the HD 10 of the entry/exit management server 104. The entry authorization management table records information indicating which user is authorized to enter which conference room. If the CPU 2 determines that a user is authorized to enter the conference room 100, the CPU 2 notifies the gate device 101 to allow the user to enter the conference room 100.

In step S203, the CPU 2 determines whether the user corresponding to the user ID has been present inside the conference room until now.

More specifically, the CPU 2 determines whether the user has been inside the conference room by a method described below. In step S202, the entry/exit management server 104 receives information indicating whether the user ID card has been placed near the reader/writer unit outside or inside the conference room 100, together with the user ID. If the CPU 2 has received information indicating that the user ID card has been placed near the reader/writer unit outside the conference room 100, the CPU 2 determines that the user has been present outside the conference room until now. Thus, the CPU 2 determines that the user has entered the conference room (NO in step S203). The process then proceeds to step S205. In step S205, the CPU 2 updates the current position information of the user to inside the conference room 100.

On the other hand, if the CPU 2 has received information indicating that the user ID card has been placed near the reader/writer unit inside the conference room 100, the CPU 2 determines that the user has been present inside the conference room until now. Thus, the CPU 2 determines that the user has exited the conference room (YES in step S203). The process then proceeds to step S204. In step S204, the CPU 2 updates the current position information of the user to outside the conference room 100. As a result, the entry/exit management server 104 can manage whether the user is present in the conference room 100.

In the above-described process illustrated in FIG. 4, the system shifts to a waiting state after step S204 and step S205. When a next person carrying the IC card passes through the gate device 101 of the conference room 100, the process is repeated from step S202.

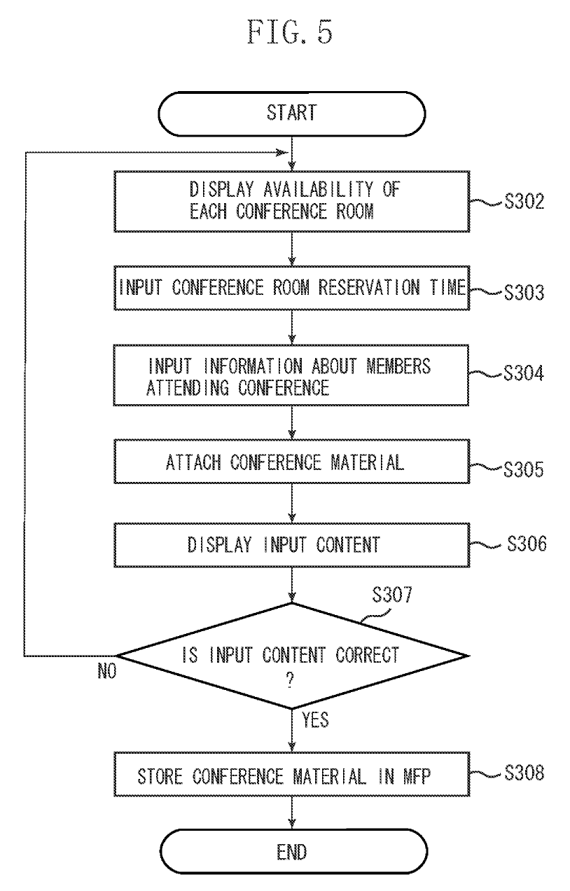

FIG. 5 is a flowchart illustrating an example of the data processing procedure in the server apparatus according to the present exemplary embodiment. The example describes a process of reserving the conference room and displaying the availability of the conference room. Each step in the flowchart is realized by the CPU 2 of the conference room reservation server 105 executing the control programs stored in the HD 10 or the PMEM 3.

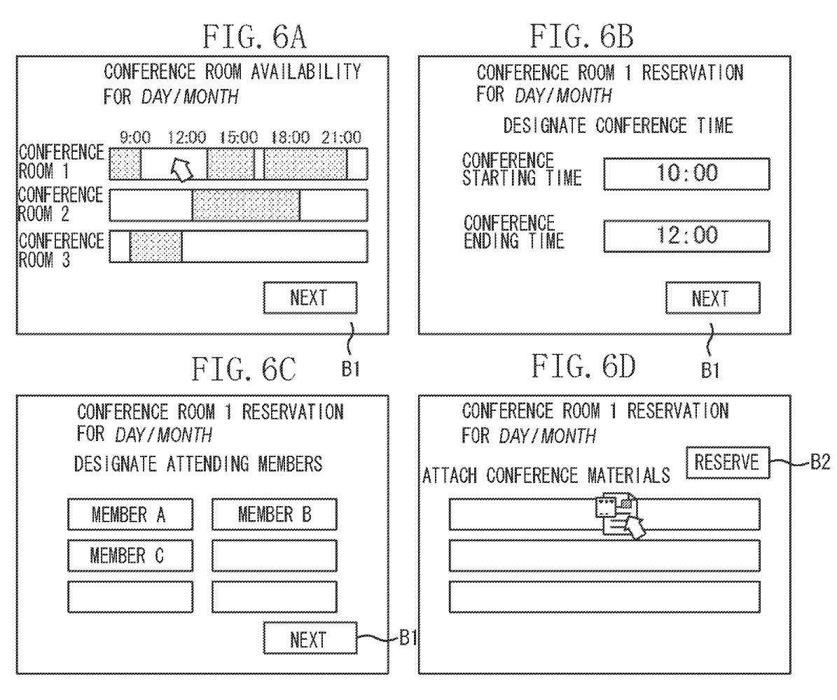

FIGS. 6A, 6B, 6C, and 6D illustrate examples of the user interface displayed on the display apparatus 16 of the client PC 106 or 107. More specifically, the client PC 106 or 107 displays screen information provided by the conference room reservation server 105 via a browser installed on the client PC 106 or 107.

FIG. 6A illustrates the screen displaying the conference room availability. More specifically, FIG. 6A illustrates the screen for confirming the availability of conference rooms 1, 2, and 3, in which a white region indicates a period of time when the conference room is not being used (not reserved). Further, a gray region indicates a period of time when the conference room is reserved. When the user clicks on the unused region and presses a “next” button B1, the screen switches to a screen illustrated in FIG. 6B.

In the screen illustrated in FIG. 6B, the user designates and inputs the starting time and the ending time of the conference to be held in the conference room 1. The user then presses the “next” button B1, and the display screen switches to a screen illustrated in FIG. 6C.

In the screen illustrated in FIG. 6C, the user has input the members attending the conference. The user then presses the “next” button B1, and the display screen changes to the screen illustrated in FIG. 6D, in which the user can store a conference material in the BOX region of the image forming apparatus 102. The user can set the conference material associated with the conference by retrieving the conference material from the client PC 106 or 107 or a folder that can be referenced on the network, and dragging and dropping the conference material in the appropriate BOX region. The user then presses a “reserve” button B2, and the conference room reservation server 105 stores in the HD 10 the items set in the screens illustrated in FIGS. 6A, 6B, 6C, and 6D in association with each other.

The procedure of reserving the conference room using the screens illustrated in FIGS. 6A, 6B, 6C, and 6D will be described below with reference to the flowchart illustrated in FIG. 5. The screens illustrated in FIGS. 6A, 6B, 6C, and 6D can be realized by a language such as hypertext markup language (HTML). Further, the conference room reservation server 105 transmits and receives information to and from the client PC via the screens illustrated in FIGS. 6A, 6B, 6C, and 6D. As a result, the conference room reservation server 105 receives information necessary for reserving the conference room and stores the information in the HD 10 of the conference room reservation server 105.

When the user accesses the conference room reservation server 105 from the client PC 106 or the client PC 107, the conference room reservation server 105 performs the process described below. The conference room reservation server 105 can also perform a predetermined authentication process, so that the process illustrated in FIG. 5 is performed only when the authentication is successful.

In step S302, the conference room reservation server 105 displays the availability of the conference room on the display apparatus 16 of the client PC 106 or the client PC 107. More specifically, the conference room reservation server 105 transmits the availability information of each conference room stored in the conference room reservation server 105 to the client PC 106 or the client PC 107. As a result, as illustrated in FIG. 6A, the availability of each conference room is displayed on the display apparatus 16 of the client PC 106 or the client PC 107. As described above, the white region on the screen illustrated in FIG. 6A indicates the period of time when the conference room is not reserved. If the user clicks on the period of time corresponding to the white region and presses the “next” button B1, the conference room reservation server 105 displays the screen illustrated in FIG. 6B for designating the reservation time on the display apparatus 16 of the client PC 106 or the client PC 107.

In step S303, the user confirms the availability information of the conference room 100 and inputs the conference starting time and the conference ending time of the period that the user desires to reserve the conference room 100. In the present exemplary embodiment, the user reserves the conference room 1 from 10:00 to 12:00, which is not currently being used. In step S303, the user thus designates 10:00 to 12:00 as the period of time for which the conference room is to be used (refer to FIG. 6B). When the user then presses the “next” button B1, the conference room reservation server 105 displays the screen for designating the members attending the conference illustrated in FIG. 6C on the display apparatus 16 of the client PC 106 or the client PC 107.

In step S304, the user inputs the information about the member attending the conference. For example, the members attending the conference are member A that has reserved the conference room, member B, and member C (refer to FIG. 6C). The user can input the information by inputting the name of the member directly using the keyboard 12 or by selecting and inputting the attending member.

In step S305, the user attaches the conference material data to be used in the conference. As illustrated in FIG. 6D, the user can designate the necessary conference material from the HD 10 of the client PC 106 or the client PC 107. The user designates the file of the conference material in an attachment box illustrated in FIG. 6D.

In step S306, the conference room reservation server 105 displays the period of time for which the conference room is to be used designated in step S303, the names of members attending the conference designated in step S304, and the file name of the conference material designated in step S305. The above-described information is displayed on the display apparatus 16 of the client PC 106 or the client PC 107 so that the user can confirm the information.

When the user presses the “reserve” button B2 illustrated in FIG. 6D, the process proceeds to step S307. In step S307, the conference room reservation server 105 confirms whether there is an error in the content input by the user. More specifically, the conference room reservation server 105 determines whether the designated time is a reasonable value, and whether the attached material is in a data format printable by the image forming apparatus 102. Further, if the conference room reservation server 105 determines that there is an error (such as the designated time is unreasonable, or the print format is not printable) (NO in step S307), the process returns to step S302 and the process is repeated.

If the conference room reservation server 105 determines that the input content is correct (YES in step S307), the process proceeds to step S308. In step S308, the conference room reservation server 105 stores in the HDD 213 of the image forming apparatus 102 the conference material file attached by the user operation on the screen illustrated in FIG. 6D. The process then ends.

The conference room reservation server 105 stores the conference material file designated in step S305 in the HDD 213 of the image forming apparatus 102 by transmitting the file via the network 103. As a result, the user can reserve each conference room via the conference room reservation server 105.

The process of automatically deleting the conference material stored in the HDD 213 inside the image forming apparatus 102 will be described below.

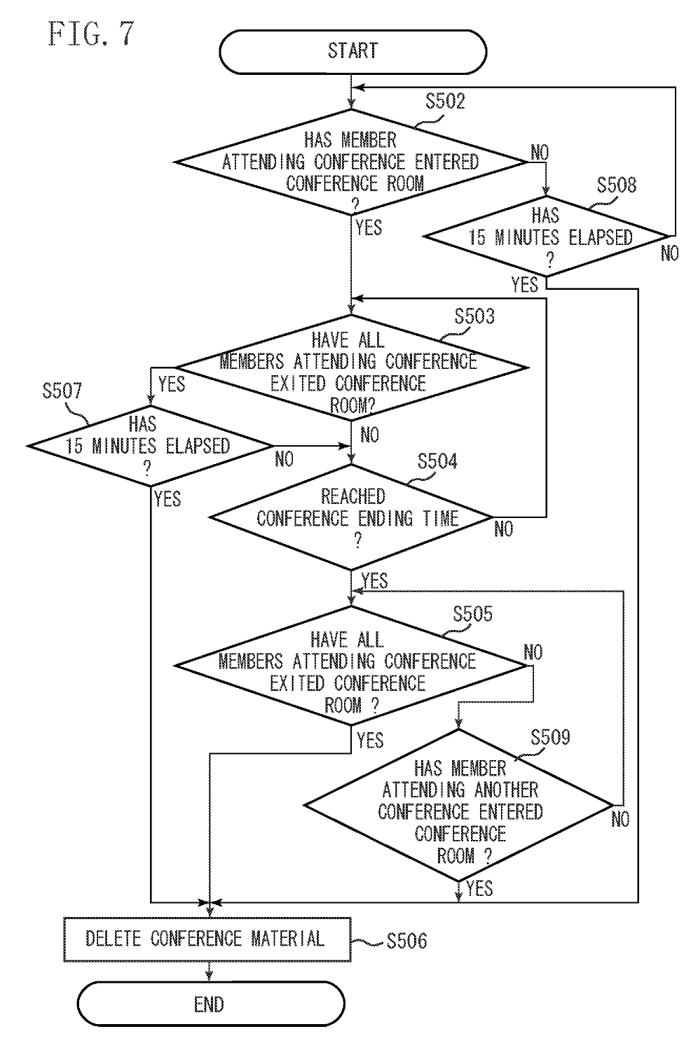

FIG. 7 is a flowchart illustrating an example of the data processing procedure in the server apparatus according to the present exemplary embodiment. The process is an example of deleting the conference material stored in the image forming apparatus 102 performed by the conference room reservation server 105. Each step in the flowchart is realized by the CPU 2 of the conference room reservation server 105 executing the control programs stored in the HD 10 or the PMEM 3.

The process illustrated in FIG. 7 is started by the conference room reservation server 105 monitoring whether the reserved conference has started via the screen illustrated in FIG. 6A and determining that the conference has started.

In step S502, the CPU 2 determines whether a member attending the conference has entered the conference room 100. More specifically, the CPU 2 of the conference room reservation server 105 determines whether the member of the conference that has started, registered on the screen illustrated in FIG. 6C, is present inside the conference room 100. The CPU 2 can determine a presence/absence of the member based on the entry/exit management status managed by the entry/exit management server 104. If the CPU 2 determines that none of the members designated as attending the conference has not entered the conference room 100 (NO in step S502), the process proceeds to step S508. In step S508, the CPU 2 determines whether a predetermined waiting time, such as 15 minutes, has elapsed. In the present exemplary embodiment, the predetermined waiting time is set as 15 minutes. However, an appropriate waiting time can be set according to the user environment. If the CPU 2 determines that the designated waiting time has not elapsed (NO in step S508), the process returns to step S502.

On the other hand, if the CPU 2 determines that the designated waiting time has elapsed (YES in step S508), the process proceeds to step S506. In step S506, the conference room reservation server 105 transmits to the image forming apparatus 102 an instruction to delete the conference material set on the screen illustrated in FIG. 6D, which is stored in the BOX region of the image forming apparatus 102. The process then ends. As a result, for example, if the conference that has been reserved via the conference room reservation server 105 has been cancelled, the conference material for the cancelled conference can be deleted.

In step S502, if the CPU 2 determines that at least one member attending the conference has entered the conference room 100 (YES in step S502), the process proceeds to step S503. In step S503, the conference room reservation server 105 determines whether all of the members that entered the conference room 100 have exited the conference room 100, based on the entry/exit management status managed by the entry/exit management server 104.

If the CPU 2 of the conference room reservation server 105 determines that all of the members have exited the conference room 100 (YES in step S503), the process proceeds to step S507. In step S507, the CPU 2 determines whether a predetermined waiting time has elapsed. In the present exemplary embodiment, the predetermined waiting time is set as 15 minutes. However, an appropriate waiting time can be set according to the user environment.

In step S507, if the CPU 2 determines that 15 minutes has elapsed (YES in step S507), the process proceeds to step S506. In step S506, the conference material is deleted as described above, and the process ends.

On the other hand, if the CPU 2 determines that 15 minutes has not elapsed (NO in step S507), the process proceeds to step S504.

In step S504, the CPU 2 determines whether the designated conference ending time has been reached. If the CPU 2 determines that the designated conference ending time has not been reached (NO in step S504), the process returns to step S503, and the process is similarly repeated. Therefore, when all of the members attending the conference have exited the conference room, the CPU 2 determines that the conference has ended, even if the conference ending time has not been reached. The conference material in the image forming apparatus 102 can thus be deleted. However, it is not necessarily the case that the conference has ended if all of the members attending the conference have exited the conference room. For example, the members may have exited the conference room during a break. Therefore, the conference material is not immediately deleted when all of the members attending the conference have exited the conference room. Thus, the conference material remains undeleted for a predetermined time, so that the members can use the conference material when the conference is resumed.

If the CPU 2 determines that the designated conference ending time has been reached (YES in step S504), the process proceeds to step S505. In step S505, the CPU 2 determines whether all of the members attending the conference have exited the conference room 100. If the CPU 2 determines that all of the members attending the conference have exited the conference room 100 (YES in step S505), the process proceeds to step S506. In step S506, the CPU 2 deletes the conference material. The process then ends.

On the other hand, if the CPU 2 determines that not all of the members attending the conference have exited the conference room 100 (NO in step S505), the process proceeds to step S509.

In step S509, the CPU 2 determines whether a member of another conference has entered the conference room 100. If the CPU 2 determines that a member of another conference has not entered the conference room 100 (NO in step S509), the process returns to step S505, and the process is repeated. In this example, the CPU 2 determines whether a member of another conference has entered the conference room 100. However, the present invention is not limited to the above, and, for example, the CPU 2 can determine whether a user (an outsider) other than the members registered as members attending the conference which is continuing has entered the conference room 100. In such a case, if the conference room reservation server 105 determines that the outsider has entered the conference room 100, the process proceeds to step S506. On the other hand, if the conference room reservation server 105 determines that the outsider has not entered the conference room 100, the process proceeds to step S505.

If the CPU 2 determines that a member of another conference has entered the conference room 100 (YES in step S509), the process proceeds to step S506. In step S506, the CPU 2 deletes the conference material. The process then ends. As described above, if there are members attending the conference remaining inside the conference room 100 when the conference ending time has been reached, the conference material stored in the HDD 213 inside the image forming apparatus 102 is not deleted. As a result, if the conference is continued after the original conference ending time, the conference members can use the conference material stored in the HDD 213 of the image forming apparatus 102.

In the present exemplary embodiment, the server apparatus that manages the conference room entry status and the server apparatus that manages the conference room reservation are separately configured in the system. However, the above-described server apparatuses can be configured as a single server apparatus.

Specific examples of the process of deleting the conference material will be separately described below.

[A Case Where the Conference has Ended as Scheduled]

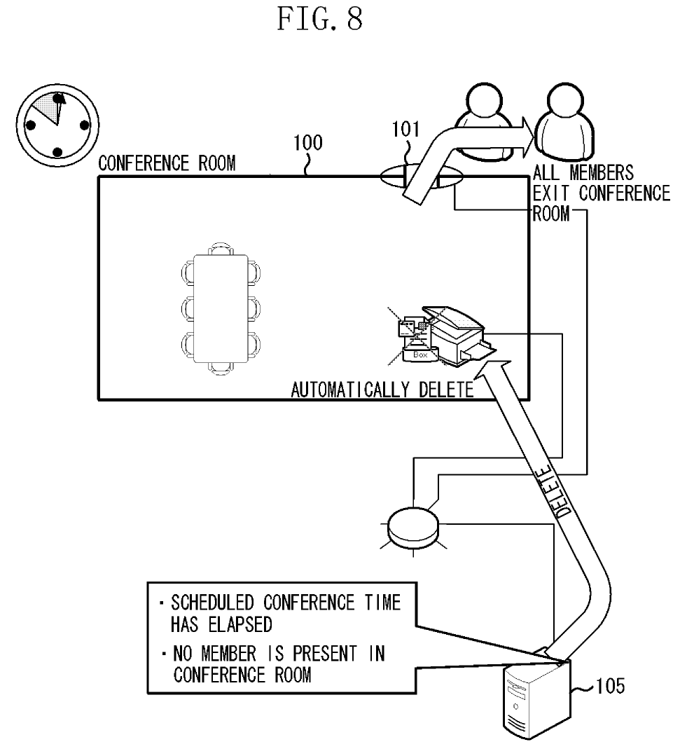

FIG. 8 illustrates an example of a process of deleting the conference material according to the present exemplary embodiment. The example illustrates deleting the conference material when the conference has ended as scheduled.

More specifically, a case where the conference held by the user reserving the conference room 1 from 10:00 to 12:00 as set in FIG. 6A has ended will be described. The conference room 1 described in FIG. 6A corresponds to the conference room 100 illustrated in FIG. 1. Further, it is supposed that the members A, B, and C who were previously registered on the conference room reservation server 105 exited the conference room 1 at 12:03.

The CPU 2 of the entry/exit management server 104 recognizes that all of the members attending the conference exited the conference room 1 at 12:03, using the reader/writer unit in the gate device 101 disposed at the doorway of the conference room 1. The CPU 2 of the entry/exit management server 104 then manages, as the entry/exit management status, that the members attending the conference are not present inside the conference room 1.

The conference room reservation server 105 regularly makes reference to the entry/exit management status managed by the entry/exit management server 104 (e.g., at every 1 minute). The conference room reservation server 105 thus recognizes that none of the members attending the conference scheduled from 10:00 to 12:00 at conference room 1 is present inside the conference room 1. In the present exemplary embodiment, the conference room reservation server 105 regularly refers to the entry/exit management status of the entry/exit management server 104. However, this is not a limitation. For example, the entry/exit management server 104 can be controlled to notify the conference room reservation server 105 of the entry/exit management status when the entry/exit management server 104 recognizes via the gate device 101 that the presence of the members inside the conference room 100 has changed.

In such a case, the CPU 2 of the conference room reservation server 105 determines that the conference has ended and that the conference material stored in the HDD 213 of the image forming apparatus 102 is to be deleted. The conference room reservation server 105 then transmits to the image forming apparatus 102 a request to delete the conference material of the conference, which has ended.

Upon receiving the deletion request from the conference room reservation server 105, the image forming apparatus 102 deletes the conference material from the HDD 213.

The process of deleting the conference material when the conference ended on schedule will be described below with reference to the flowchart illustrated in FIG. 7.

In step S502, the CPU 2 of the entry/exit management server 104 determines whether at least one of the members attending the conference has entered the conference room 1. Since the member attending the conference has entered the conference room before the starting time of the conference (YES in step S502), the process proceeds to step S503. In the present exemplary embodiment, since all of the members attending the conference did not exit the conference room 100 before 12:00 when the conference was scheduled to end (NO in step S503 and YES in step S504), the process proceeds to step S504 and to step S505.

In the present example, no member attending another conference has entered the conference room and all members have exited the conference room by 12:03. The CPU 2 thus proceeds to and performs the process of step S506 at 12:03.

More specifically, the CPU 2 of the conference room reservation server 105 outputs a request to the image forming apparatus 102 to delete the conference material file stored in the HDD 213. The image forming apparatus 102 then deletes the conference material.

The conference material for the conference is thus automatically deleted from the HDD 213 of the image forming apparatus 102, and the process ends.

By performing the above-described process, the conference material previously registered to be used in the conference is automatically deleted when the conference ends. The conference material is automatically deleted by the CPU 2 of the conference room reservation server 105 determining the time when the conference ended.

As a result, the conference material can be output from the image forming apparatus 102 as desired during the conference and is automatically deleted when the conference ends without the instruction from the member attending the conference. Therefore, the conference material stored in the HDD 213 of the image forming apparatus 102 is not continuously stored in the HDD 213 by the user forgetting to delete the conference material, so that the security can be improved. The image forming apparatus 102 may transmit, via the network 103, an e-mail notifying of the completion of deletion of the conference material to all of the members or a specified member.

[A Case Where the Conference is Determined to have Ended Earlier than Scheduled]

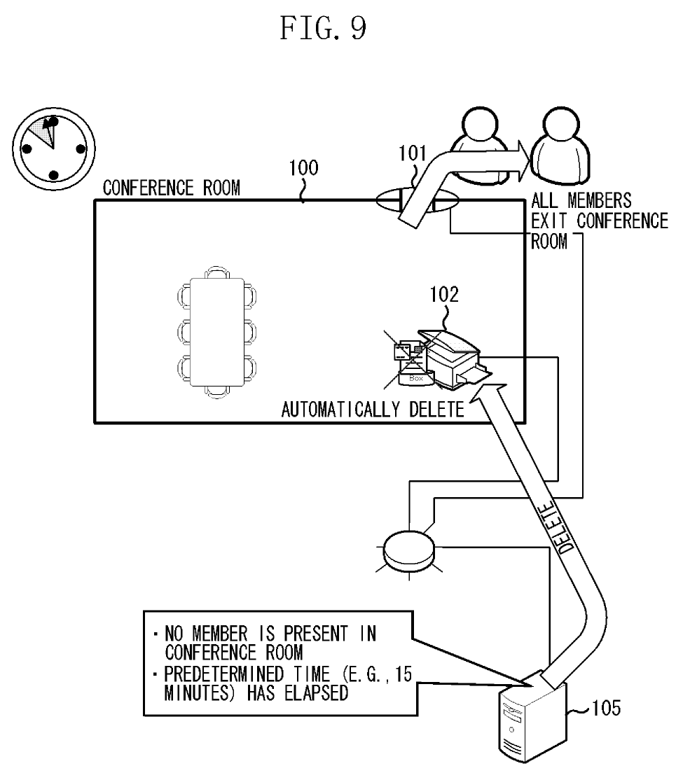

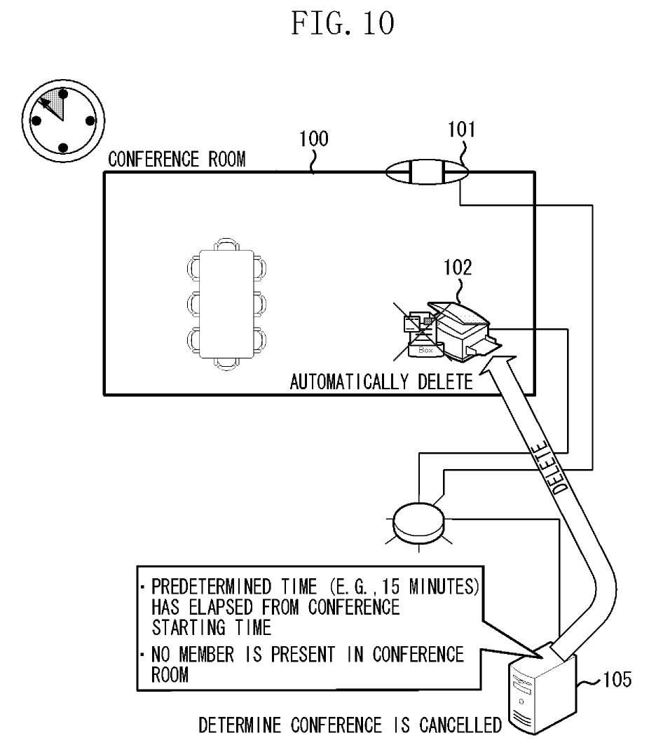

FIG. 9 illustrates an example of a process of deleting the conference material according to the present exemplary embodiment. The example describes a process of deleting the conference material when the conference has ended earlier than scheduled.

More specifically, a case where the conference held in the conference room 1 ended earlier than the conference time previously reserved by the user will be described below.

For example, if all of the members attending the conference exited the conference room 1 at 11:30, the entry/exit management server 104 recognizes that all of the members attending the conference exited the conference room 1 at 11:30. The entry/exit management server 104 recognizes that fact via the reader/writer unit in the gate device 101. The entry/exit management server 104 thus manages as the entry/exit management status that all of the members attending the conference have exited the conference room 1.

The conference room reservation server 105 then refers to the entry/exit management server status managed by the entry/exit management server 104 and recognizes that no member attending the conference is remaining inside the conference room 1. In such a case, since the conference has ended before reaching the reserved conference ending time, the conference room reservation server 105 does not immediately delete the conference material previously stored in the HDD 213 of the image forming apparatus 102 to be used in the conference. Instead, the conference room reservation server 105 deletes the conference material stored in the HDD 213 when a predetermined time (e.g., 15 minutes) has elapsed. This is designed in consideration of the case where the conference may be resumed by the members re-entering the conference room before the conference ending time is reached. In such a case, the conference material necessary for the conference may be used in the conference.

More specifically, the conference room reservation server 105 deletes the conference material after a predetermined time has elapsed from 11:30 when all of the members attending the conference have exited the conference room 1.

For example, if none of the members attending the conference has entered the conference room 1 for 15 minutes, the conference room reservation server 105 determines for the first time at 11:45 that the conference material has become unnecessary. The conference room reservation server 105 then transmits the deletion request to the image forming apparatus 102 as the conference material has become invalid. 15 minutes is an example, and an appropriate time can be set according to an established practice of the conference held using the present system.

Upon receiving the deletion request from the conference room reservation server 105, the image forming apparatus 102 deletes the conference material from the HDD 213.

If it is determined that even one member attending the conference re-entered the conference room 1 before 11:45, a timer which counts the predetermined 15 minutes is reset. The predetermined 15 minutes is then re-counted from the time when all of the members attending the conference have exited the conference room 1.

Further, if all of the members attending the conference have exited the conference room 1 at 11:50, the previously reserved conference ending time (i.e., at 12:00) is reached before 15 minutes elapses from 11:50. In such a case, the conference room reservation server 105 can transmit the request to delete the conference material to the image forming apparatus 102 at 12:00. Alternatively, the conference room reservation server 105 can transmit the request to delete the conference material at 12:05 instead of at 12:00. If the conference room reservation server 105 is to transmit the deletion request at 12:05, the members attending the conference can use the conference material stored in the image forming apparatus 102 when the conference is resumed at 12:03. Upon receiving the deletion request from the conference room reservation server 105, the image forming apparatus 102 deletes the conference material from the HDD 213.

The process of deleting the conference material when the conference ended earlier than scheduled will be described below with reference to the flowchart illustrated in FIG. 7.

In step S502, the CPU 2 determines whether at least one of the members attending the conference has entered the conference room. In the present example, the conference member has entered the conference room before the starting time (YES in step S502). The process thus proceeds to step S503. In the present example, the conference has ended at 11:30 before the previously reserved conference ending time (i.e., 12:00), and all of the members attending the conference have then exited the conference room. The CPU 2 thus determines that all of the members have exited the conference room (YES in step S503). The process then proceeds to step S507.

In step S507, the CPU 2 determines whether 15 minutes has elapsed from the time when all of the members attending the conference exited the conference room. If 15 minutes has not elapsed (NO in step S507), the process proceeds to step S504. In step S504, the CPU 2 determines whether the conference ending time has been reached before 15 minutes has elapsed.

In the present example, 15 minutes has elapsed at 11:45. Therefore, after step S504, the process repeats step S503, step S507, and step S504. When the time becomes 11:45, the CPU 2 determines that 15 minutes has elapsed in step S507 (YES in step S507), and the process proceeds to step S506.

In step S506, the conference has ended, and the conference room reservation server 105 outputs to the image forming apparatus 102 the request to delete the conference material file stored in the HDD 213. The image forming apparatus 102 then deletes the conference material. The conference material is automatically deleted according to the above-described process, and the process ends.

In the present exemplary embodiment, if all of the members attending the conference exited the conference room at 11:50, the conference ending time (i.e., 12:00) is reached while the process of step S503, step S507, step S504, to step S503 is repeated. Therefore, the process proceeds from step S504 to step S505 when the time becomes 12:00 (i.e., YES in step S504) In step S505, since all of the members attending the conference have exited the conference room (YES in step S505), the process proceeds to step S506, and the image forming apparatus 102 deletes the conference material. The process then ends.

By the above-described process, the previously registered conference material to be used in the conference is automatically deleted by the system determining that the conference has ended.

As a result, the conference material can be output from the image forming apparatus 102 at arbitrary timing during the conference and can be automatically deleted when the conference ends without the instruction from the members attending the conference. Further, if the conference ends earlier than scheduled, the conference material is deleted before the scheduled conference ending time is reached. The security level of the conference material stored in the HDD 213 of the image forming apparatus 102 can thus be improved.

Furthermore, the conference material can remain stored during a predetermined time. Therefore, if the conference is resumed after all of the members attending the conference temporarily exited the conference room before the conference ending time, the conference material can be output.

[A Case Where the Conference is not Held]

FIG. 10 illustrates an example of the process of deleting the conference material according to the present exemplary embodiment. The example illustrates deleting the conference material when the conference is not held.

More specifically, a case where the conference which was reserved to be held in the conference room 1 is not held even after the conference starting time (i.e., 10:00) has been reached will be described below.

For example, none of the members attending the conference enters the conference room by the previously reserved conference starting time. The conference room reservation server 105 then receives information from the entry/exit management server 104 that none of the members has entered the conference room after a predetermined time of 15 minutes has elapsed from the conference starting time of 10:00, i.e., at 10:15.

In such a case, the conference room reservation server 105 determines at 10:15 that the previously reserved conference has been cancelled.

The conference room reservation server 105 then transmits to the image forming apparatus 102 the request to delete the conference material stored in the HDD 213 of the image forming apparatus 102. The conference room reservation server 105 may transmit, before deleting the conference material, an e-mail notifying of deleting the conference material to the member registered as a person to be notified or to all of the members. The conference room reservation server 105 can then delete the conference material only when confirmation is received. As a result, the conference material can be prevented from being deleted even when the conference has not been cancelled.

The process of deleting the conference material when the conference is not held will be described below with reference to the flowchart illustrated in FIG. 7.

In step S502, the CPU 2 determines whether at least one of the members attending the conference has entered the conference room. In the present example, none of the members attending the conference enters the conference room after 15 minutes has elapsed from 10:00, which is the conference starting time (NO in step S502 and YES in step S508). Therefore, the process proceeds to step S508 and to step S506.

Since the CPU 2 determines that the conference has been cancelled at 10:15, in step S506, the conference room reservation server 105 transmits to the image forming apparatus 102 the request to delete the conference material file stored in the HDD 213 of the image forming apparatus 102. The image forming apparatus 102 then deletes the conference material. The conference material is thus automatically deleted, and the process ends.

By the above-described process, the conference material previously registered to be used in the conference is automatically deleted before the conference ending time. As a result, if the conference is cancelled, the possibility of the conference material to be viewed by a member other than the members attending the conference before reaching the conference ending time can be reduced. Therefore, the security level of the conference material can be maintained.

[Control Selectively Performed when the Members Remain Inside the Conference Room after the Conference Ending Time]

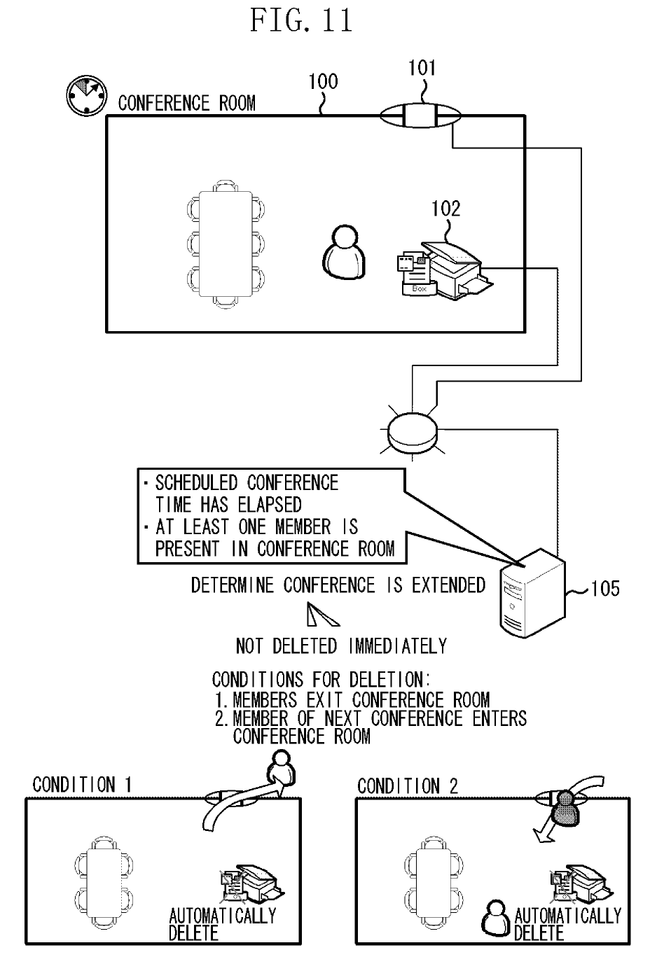

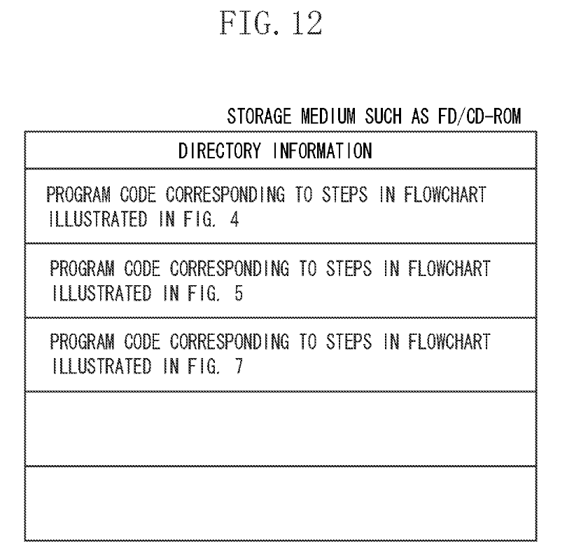

FIG. 11 illustrates an example of the process of deleting the conference material according to the present exemplary embodiment. The example illustrates deleting the conference material when the members remain inside the conference room after the conference ending time.

More specifically, a case where the conference held in the conference room 1 is continued without ending after the previously reserved conference ending time has been reached will be described.

For example, at least one of the members attending the conference remains inside the conference room 1 at 12:00, which is the conference ending time previously reserved by the user on the conference room reservation server 105. In such a case, the conference room reservation server 105 determines, from the entry/exit management information received from the entry/exit management server 104, that the conference has not ended and is continuing (extended).

When the conference is extended as described above, the conference material may be used after the conference ending time. The conference room reservation server 105 thus does not immediately delete the conference material. Therefore, the conference material is deleted by considering two cases to be described below.

In a first case, all of the members attending the conference exit the conference room 1 at 12:12.

In such a case, the conference room reservation server 105 transmits the deletion request to the image forming apparatus 102 at 12:12. Upon receiving the deletion request from the conference room reservation server 105, the image forming apparatus 102 deletes the conference material from the HDD 213.

In a second case, at least one of the members attending the conference remains inside the conference room 1 after the conference ending time of 12:00. Further, a person who is not a member attending the conference has entered the conference room 1. In such a case, the conference room reservation server 105 determines that the person has entered the conference room to start the next conference.

For example, if the person who is not a member attending the conference entered the conference room at 12:10, the conference room reservation server 105 deletes the conference material of the conference. The conference material thus can be prevented from being viewed by the person, who is not a member of the conference.

More specifically, the conference room reservation server 105 transmits to the image forming apparatus 102 the request to delete the conference material, which has become invalid. Upon receiving the deletion request from the conference room reservation server 105, the image forming apparatus 102 deletes the conference material from the HDD 213.

The process of deleting the conference material when the member of the conference remains inside the conference room after the conference ending time will be described below with reference to the flowchart illustrated in FIG. 7.

In the present exemplary embodiment, the conference started at the conference starting time of 10:00, and a member attending the conference remains inside the conference room at 12:00. Therefore, the process proceeds from step S502 to step S503 and to step S504 in the flowchart. In step S504, the process proceeds to step S505 at 12:00 when the conference ending time is reached. In step S505, the CPU 2 determines whether all of the members attending the conference have exited the conference room.

In the present example, the conference is continued after 12:00 and the members still remain inside the conference room at 12:00 (NO in step S505). The process then proceeds to step S509.

In the above-described first case, all of the members attending the conference finally exit the conference room at 12:12. The process is thus repeated from step S505 to step S509 and to step S505 until 12:12 is reached.

At 12:12, all of the members exit the conference room, and in step S505, the CPU 2 determines that all of the members attending the conference have exited the conference room (YES in step S505). The process then proceeds to step S506.

In step S506, the conference room reservation server 105 outputs to the image forming apparatus 12 the request to delete the conference material file stored in the HDD 213 of the image forming apparatus 102. The image forming apparatus 102 then deletes the conference material to be used in the conference stored in the HDD 213 according to the deletion instruction. The conference material is thus automatically deleted, and the process ends.

In the above-described second case, the process from step S505 to step S509 and to step S505 is repeated until a member of another conference enters the conference room at 12:10.

At 12:10, the member of another conference enters the conference room, and in step S509, the CPU 2 determines that the member of another conference entered the conference room (YES in step S509). The process then proceeds to step S506.

When the member of another conference enters the conference room in step S506, the conference material presently stored in the HDD 213 of the image forming apparatus 102 may become viewed by the member of another conference. Therefore, the CPU 2 invalidates the conference material, and the image forming apparatus 102 becomes unable to output the conference material thereafter. The conference room reservation server 105 outputs to the image forming apparatus 102 the request to delete the conference material file stored in the HDD 213 of the image forming apparatus 102. Upon receiving the request, the image forming apparatus 102 deletes the conference material stored in the HDD 213 according to the deletion instruction. The conference material is thus automatically deleted, and the process ends.

By the above-described process, the conference material previously registered to be used in the conference is automatically deleted by the conference room reservation server 105 determining that the conference has ended.

As a result, the conference material can be output at arbitrary timing from the image forming apparatus 102 during the conference. Further, the conference material can be automatically deleted when the conference ends without the member attending the conference instructing the deletion of the conference material. The security of the conference material stored in the HDD 213 of the image forming apparatus 102 can thus be improved.

Furthermore, when a member attending the next conference enters the conference room, the previous conference is ended and the conference material used in the previous conference is automatically deleted. As a result, the possibility of the conference material to be viewed by a member other than the members attending the conference in which the conference material is used is reduced. Therefore, the security of the conference material stored in the HDD 213 of the image forming apparatus 102 can be maintained.

As described above, the conference room reservation server 105 controls the deletion of the conference material stored in the image forming apparatus 102 installed inside the conference room. The conference room reservation server 105 performs such control based on the previously set conference information and the presence of the members inside the conference room. The conference information includes information about the conference room, conference starting time, the conference ending time, and the members attending the conference, which are set using the interfaces illustrated in FIGS. 6A, 6B, 6C, and 6D.

As a result, the conference material stored in the HDD 213 of the image forming apparatus 102 can be deleted according to the status of the conference, in addition to being deleted at a predetermined time.

In the present exemplary embodiment, the conference room reservation server 105 transmits the deletion request to the image forming apparatus 102 at predetermined timing, and the conference material file is actually deleted.

However, the conference material can be invalidated without actually deleting the conference material, so that the conference material cannot be used in the image forming apparatus 102. The conference material can be printed, displayed, and transmitted.

A configuration of a data processing program readable by the server apparatus according to an exemplary embodiment of the present invention will be described below with reference to a memory map illustrated in FIG. 12.

FIG. 12 illustrates the memory map of a storage medium storing the various data processing programs readable by the apparatuses according to the present exemplary embodiment

Further, information for managing program groups stored in the storage medium, such as version information and creator, and information that depends on an operation system (OS) of an apparatus that reads the program, such as an icon to be displayed to identify a program, can be stored in the storage medium (not illustrated).

Data that is dependent on the various programs can be managed in the above-described directory. Further, a program for installing the various programs on a computer or a program for decompressing a compressed program that is to be installed can be stored in the storage medium.

Furthermore, functions illustrated in FIGS. 4, 5, and 7 can be performed by a host computer executing a program installed from an external source. In such a case, the present invention is applicable if an information group including the program is supplied to an output apparatus from a storage medium such as a compact disc-read-only memory (CD-ROM), flash memory, or FD, or from an external storage medium via a network.

The present invention can also be achieved by providing a storage medium which stores software (program code) for implementing functions of the above-described exemplary embodiments, to a system or an apparatus. The program code stored in the storage medium can be read and executed by a computer (CPU or micro-processing unit (MPU)) of the system or the apparatus.

In this case, the software (program code) itself realizes the novel functions of the above-described exemplary embodiments. The software (program code) itself and the storage medium that stores the software (program code) constitute the present invention.

A computer executable program to implement the above-mentioned exemplary embodiments can take any form readable by computer, for example, object code, a program executed by an interpreter, or script data supplied to an operating system (OS).

The storage medium can be, for example, a floppy disc (FD), a HD, a magneto-optical disk (MO), a CD-ROM, a CD-readable (R), a CD-rewritable (RW), a magnetic tape, a nonvolatile memory card, a ROM, or a digital versatile disc (DVD).

In this case, the software (program code) itself realizes the functions of the above-described exemplary embodiments. The software (program code) itself and the storage medium that stores the software (program code) constitute the present invention.

Such software (program code) can also be supplied by the system or the apparatus accessing a web page on the Internet through the browser of a client computer. The software (program code) itself or a compressed file including an auto-install function can be downloaded from the web page onto a hard disk. In addition, the program code can be broken up into a plurality of files, and each file can be downloaded from different web pages. Namely, the present invention can be applied to a World Wide Web (WWW) server or a file transfer protocol (FTP) server that allow numerous users to download the program files so that the functions or processes of the present invention can be realized on their computers.

Further, such software (program code) can be encrypted and stored in a storage medium, such as a CD-ROM, to be distributed to users. A user who meets given conditions can download the key information for decrypting the program from a web page through the Internet. By using the key information, the encrypted program can be executed and installed on a computer to realize the functions of exemplary embodiments of the present invention.

Furthermore, the above-described exemplary embodiments can be not only realized by executing software (program code) read by a CPU. An OS or the like working on a computer can also perform a part or the whole of processes according to instructions of the software (program code) and realize functions of the above-described exemplary embodiments.

Moreover, software (program code) read from a storage medium can be stored in a memory equipped in a function expansion board inserted in a computer or a function expansion unit connected to a computer, and a CPU in the function expansion board or the function expansion unit can execute all or a part of the processing based on the instructions of the software (program code) to realize the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-212626 filed Aug. 21, 2008, which is hereby incorporated by reference herein in its entirety.

What is claimed is:

1. A data processing apparatus capable of communicating with a management apparatus that manages a starting date and time and an ending date and time of a conference to be held in a conference room and a presence/absence of a participant attending the conference in the conference room, the data processing apparatus comprising:
a storage unit configured to store electronic data managed in association with the conference; and
a control unit configured to invalidate the electronic data stored in the storage unit based on the starting date and time of the conference and the presence/absence of the participant in the conference room or the ending date and time of the conference and a presence/absence of a person in the conference room, which are managed by the management apparatus.

2. The data processing apparatus according to claim 1, wherein the control unit invalidates the electronic data in a case where the participant does not enter the conference room even after a predetermined time has elapsed from the starting date and time.

3. The data processing apparatus according to claim 1, wherein the control unit invalidates the electronic data in a case where a predetermined time has elapsed while the participant has exited the conference room before the ending time and date of the conference room is reached.

4. The data processing apparatus according to claim 1, wherein the control unit invalidates the electronic data in a case where the participant has exited the conference room after the ending date and time of the conference has been reached.

5. The data processing apparatus according to claim 1, wherein the control unit invalidates the electronic data in a case where a person other than the participant attending the conference has entered the conference room after the ending date and time of the conference has been reached.

6. A control method for controlling a data processing apparatus capable of communicating with a management apparatus that manages a starting date and time and an ending date and time of a conference to be held in a conference room and a presence/absence of a participant attending the conference in the conference room, the method comprising:
storing electronic data managed in association with the conference in a storage unit; and
invalidating the electronic data stored in the storage unit based on the starting date and time of the conference and the presence/absence of the participant in the conference room or the ending date and time of the conference and a presence/absence of a person in the conference room, which are managed by the management apparatus.

7. A management system including a data processing apparatus and a management apparatus that manages information about a conference to be held in a conference room,
wherein the management apparatus comprises a management unit configured to manage a starting date and time and an ending date and time of a conference to be held in the conference room and a presence/absence of a participant attending the conference in the conference room, and
wherein the data processing apparatus comprises:
a storage unit configured to store electronic data managed in association with the conference; and
a control unit configured to invalidate the electronic data stored in the storage unit based on the starting date and time of the conference and the presence/absence of the participant in the conference room or the ending date and time of the conference and a presence/absence of a person in the conference room, which are managed by the management apparatus.

8. A computer-readable storage medium storing a computer-executable program for controlling a data processing apparatus capable of communicating with a management apparatus that manages a starting date and time and an ending date and time of a conference to be held in a conference room and a presence/absence of a participant attending the conference in the conference room, the computer-executable program comprising:
storing electronic data managed in association with the conference in a storage unit; and
invalidating the electronic data stored in the storage unit based on the starting date and time of the conference and the presence/absence of the participant in the conference room or the ending date and time of the conference and a presence/absence of a person in the conference room, which are managed by the management apparatus.
